(19) United States
(12) Patent Application Publication
(10) Pub. No.: US 2020/0005387 A1
(43) Pub. Date: Jan. 2, 2020

(54) METHOD AND SYSTEM FOR AUTOMATICALLY GENERATING PRODUCT VISUALIZATION FROM E-COMMERCE CONTENT MANAGING SYSTEMS

(71) Applicant: Vimeo, Inc., New York, NY (US)

(72) Inventors: Alexander RAV-ACHA, Rehovot (IL); Oren BOIMAN, Sunnyvale, CA (US)

(73) Assignee: Vimeo, Inc., New York, NY (US)

(21) Appl. No.: 16/460,380

(22) Filed: Jul. 2, 2019

Related U.S. Application Data
(60) Provisional application No. 62/692,882, filed on Jul. 2, 2018.

(51) Int. Cl. G06Q 30/06; H04N 21/8549; G06F 17/27

(52) U.S. Cl. CPC G06Q 30/0643; G06F 17/278; G06Q 30/0627; H04N 21/8549

(57) ABSTRACT

A method and a system for automatically generating a product visualization using video, based on meta data obtained from a content management system (CMS) are provided herein. The method may include: obtaining product images and meta-data linked to the product from the CMS; selecting a product visualization instruction set; modifying the product visualization instruction set based on at least one of: content of the product images, and content of the meta-data linked to the product, by adjusting one or more instructions in the instruction set, to yield a modified product visualization instruction set; applying the modified product visualization instruction set to the product images and the meta-data linked to the product, to generate a visualization of the product, wherein the product visualization includes a sequence of frames wherein at least one of the frames includes one or more of the product images together with visual representation of the meta data.

### CROSS-REFERENCE TO RELATED APPLICATIONS

This application claims the benefit of U.S. Provisional Patent Application No. 62/692,882, filed on Jul. 2, 2018, which is incorporated herein by reference in its entirety.

### FIELD OF THE INVENTION

The present invention relates generally to the field of product visualization and, more particularly, to automatically generating a product visualization from a content management system (CMS) through visual or textual analysis.

### BACKGROUND OF THE INVENTION

Prior to the background of the invention being set forth herein, it may be helpful to provide definitions of certain terms that will be used hereinafter.

The term “product visualization” as used herein is the process of creating a video or multimedia that presents a product (usually consumer product) by showing it or parts thereof in conjunction with some visualized information associated with it. Sometimes, but not exclusively, this visualization is used for e-commerce purposes.

The term “video production” as used herein is the process of creating a video that is a compilation of source footage being video clips and images, and from textual assets. Video production usually consists of the stages of footage selection and post-production. Video production can be generated from any type of media entity which defines still images as well as video footage of all kinds.

The term “content management system” or “CMS” as used herein is a system that manages the creation and modification of digital content. It typically supports multiple users in a collaborative environment. CMSs are widely used for either enterprise content management or web content management. Most CMSs include Web-based publishing, format management, history editing and version control, indexing, search, and retrieval. By their nature, content management systems support the separation of content and presentation. A web content management system (WCM or WCMS) is a CMS designed to support the management of the content of Web pages. Most popular CMSs are also WCMSs. Web content includes text and embedded graphics, photos, video, audio, maps, and program code (such as for applications) that displays content or interacts with the user.

Such a content management system (CMS) typically has two major components. A content management application (CMA) is the front-end user interface that allows a user, even with limited expertise, to add, modify, and remove content from a website without the intervention of a webmaster. A content delivery application (CDA) compiles that information and updates the website. Digital asset management systems are another type of CMS. They manage content with clearly defined author or ownership, such as documents, movies, pictures, phone numbers, and scientific data. Companies also use CMSs to store, control, revise, and publish documentation.

As product visualization takes an important part in online advertisement campaigns and customized product webpages, it would be advantageous to provide a method to automatically generate product visualization with minimal or any user input, using video production techniques.

### SUMMARY OF THE INVENTION

In accordance with some embodiments of the present invention, a method and a system for automatically generating a product visualization using video based on meta data obtained from a content management system (CMS) are provided herein. The method may include the following steps: obtaining one or more product images and meta-data linked to the product from the CMS; selecting a product visualization instruction set from a plurality of product visualization instruction sets; modifying the product visualization instruction set based on at least one of: content of the product images, and content of the meta-data linked to the product, by adjusting one or more instructions in the instruction set to yield a modified product visualization instruction set; applying the modified product visualization instruction set to the product images and the meta-data linked to the product, to generate a visualization of the product, wherein the product visualization comprises a sequence of frames wherein at least one of the frames includes one or more of the product images together with visual representation of one or more of the meta data.

These additional, and/or other aspects and/or advantages of the present invention are set forth in the detailed description which follows.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a non-limiting exemplary system in accordance with some embodiments of the present invention;

FIG. 2 is a flowchart diagram illustrating a non-limiting exemplary method in accordance with some embodiments of the present invention;

FIG. 3 is a diagram illustrating an exemplary product in accordance with some embodiments of the present invention;

FIG. 4 is a timeline diagram illustrating a non-limiting exemplary product visualization in accordance with some embodiments of the present invention;

FIG. 5 is a timeline diagram illustrating a non-limiting exemplary product visualization in accordance with some embodiments of the present invention; and

FIG. 6 is a block diagram illustrating a non-limiting exemplary implementation for the product visualization process in accordance with some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In accordance with some embodiments of the present invention, a method and a system implementing a fully automatic generation of a video visualization of a product from product images and product meta-data obtained from a CMS are provided herein.

In accordance with some embodiments of the present invention, this automatic generation consists of (a) either an API to the CMS, or a web-scrapping module, where information from one or more of the products is obtained, and (b) a product visualization module, where the extracted information is integrated into a produced video.

The information about a product may include, but is not limited to, visual footage (images and videos), textual information (e.g., product name, company name, and the like), product meta-data (e.g., price, reduction, availability) and optionally additional meta-data (e.g., brand colors, fonts, the target audience of the business, and the like).

The product visualization may be carried using various methods for automatic product visualization, for example using the product visualization methods known in the art for automatically generating a video from an input set of photos and one or more text messages (e.g., price, call-to-action, and the like). The result of the product visualization is a produced video that displays the input information in a visually pleasant way, usually having visual effects and transitions and usually being attached with a music.

### Storytelling Guided by a Story Description File

In accordance with some embodiments of the present invention, the product visualization is guided by a story description file, which may be a parameter file (e.g., XML or JSON) that is external to the product visualization unit.

This story description file defines a set of story buckets, which are story units in the resulting edited video. Each story bucket represents a shot in the produced video. During editing, each story bucket may be attached with footage and/or one or more text messages.

The description file may define the order of the story buckets; it may consist of conditions for selecting each story bucket, and it may also include rules for the selection of footage or of text messages, either general rules or rules per story bucket. The description file may also define other elements of the storytelling, for example the framing or the object to focus on in each story bucket.

The product visualization may be done based on story-telling logic, which may be based both on guides from the Story Description File and on general story-telling rules, e.g., adding a preference for displaying multiple instances of the same object sequentially, rather than jumping between different objects.

In accordance with some embodiments of the present invention, the story description file includes rules that refer to objects detected in the footage. For example, the first story bucket may include a rule that the footage that is attached to this bucket should include an object of type ‘product’ (e.g., ‘clothing’, ‘car’, ‘cell-phone’), or should not include a ‘person’. In order to implement such object-based rules, the product visualization module should include a visual footage analysis stage (video or image analysis), where objects in the footage are detected. Object detection can be done using various of well know methods in the field of computer vision.

In accordance with some embodiments of the present invention, the story description file is a full timeline, i.e., it includes the timings and optionally additional parameters of each shot in the produced video. However, for each item in the timeline, the identity of the footage attached to it is not pre-defined but rather is selected automatically based on the analysis of the content of the footage. In other words, the placement of photos or videos in the timeline is not trivial (e.g., simply based on the chronological time of the visual assets) but rather is based on visual meta-data that describes the visual content of the footage. This meta-data is extracted automatically using visual analysis. For example, based on objects detected applied on the footage or based on image or video descriptors computed from the footage.

### Object Based Story Telling

In one embodiment of the invention, the product visualization module consists of: detecting at least one object in the one or more images; deriving one or more relationships between at least two of: the background, the at least one object, or a portion thereof; determining, based on the derived one or more relationships, a spatio-temporal arrangement of at least two of: at least one portion of the one or more images, the at least one detected object, or a portion thereof; and producing a clip based on the determined spatio-temporal arrangement.

In one embodiment of the invention, the object is the product being presented in an e-commerce web-page, and the relationship between different objects may be photos of the same product, different photo angles of the same product (e.g., front vs. rear in a car), the same product at different colors or variants, or photos of different products in the same collection.

In another embodiment of the invention, the portions for which relationships are computed can be semantically meaningful parts of the product (e.g., wheels of a car, buckle of a bag, and the like). In another embodiment of the invention, the image portions may be salient portions of the product image.

In accordance with some embodiments of the present invention, the story telling rules include specific rules for editing videos from e-commerce sites, such as identifying product vs. non-product photos, and applying different logics accordingly, such as displaying a product photo in the first shot, or using specific effects for product photos (e.g., displaying multiple semantic parts of a product photo).

In accordance with some embodiments of the present invention, the placing of one or more text messages is determined based on visual footage analysis, e.g., displaying speed information of a car for sale together with an interior photo of the car or displaying available colors of a car together with an exterior photo of the car; or determining the position of a text message near the border of the product, or within a portion that does not occlude important parts of the product. The location of products or parts thereof may be determined using various object detection methods that exists in the literature.

In accordance with some embodiments of the present invention, not only the location of objects is extracted (e.g., via object detection) but also their mask (or support), e.g., using semantic segmentation. The mask can be used to further improve the story-telling logics, e.g., by making more accurate decision of where text can be positioned so that it will not occlude the product or so that it will be aligned with the contour of the product.

In one embodiment on the invention, multiple parts of the same product may be displayed simultaneously in the same video shot (i.e., a mosaic of product parts).

Creating a Produced Video that Visualizes a Single Product

In accordance with some embodiments of the present invention, the input to the proposed method is a content management system associated with a single product, in which case the produced video is a video that describes this product. The information extracted from this page may be: one or more product photos (or video), the price (and/or price reduction), the product name, the store name, product category, and the like.

The produced video may include the following shots: (a) a full-frame display of the product, (b) one or more partial shots of the product (e.g., displaying semantic parts of the product), and (c) textual information, either stand-alone or attached with some visual information.

In one embodiment of the invention, the produced video may be placed automatically in the product webpage, thus becoming an integral part of the product webpage. In this case, the automatic producing of the video is used for automatically enriching the product webpage with video.

### Text Analysis

In some embodiments of the invention, the obtaining of the product meta-data is followed by (or uses) a text analysis module, which may be used for:
Selecting key sentences that will be displayed in the produced video.
Extracting key phrases that will be displayed in the produced video.
Deciding on the most important textual information to be presented in the video.
Extracting pre-defined pieces of information such as price, price reduction, store name, produce name and the like.

These pieces of information may be simply obtained from the CMS without any text analysis, but in some cases this is not enough, and text analysis is essential to extract some of the information (e.g., when the ‘product description’ field mixes multiple information pieces such as the actual product name and the store name).

Text analysis can be done using a large number of recent methods, for examples, based on word-to-vector embedding methods such as natural language processing (NLP).

In some cases, text analysis is applied to obtain textual content that will be used in the product visualization, for example, extracting a key sentence and using this sentence in the resulting video.

### Web Scrapping

The meta-data associated to a product or a set of products can be obtained directly from a CMS, e.g., via an API. However, in some case, there is no direct access to the CMS, and which case, web scrapping can be used to extract this meta-data. Web scrapping is the process of extracting information from a set of product webpages. Web-scrapping may be based on a pre-defined structure of the page (e.g., in some e-commerce sites, where the structure of the html pages is constant across products, or has simple variations), or it may be based on a more general analysis of the page. The extracted information may include pre-defined structured data such as price, product-name, store-name, logo, product photos or videos, phone number, address, and the like, or less structured data, such as the product description, user reviews, and the like, or even data that is not pre-defined and varies from page to page.

### Visualized Representation of Non-Visual Attributes

In some embodiments of the invention, the product visualization module includes creating novel visual representations of non-visual assets. This can be done by generating visual effects that are parameterized over meta-data that is extracted from the product webpages. For example, average product user-rating can be represented visually using a visual effect or animation of stars, wherein the number of stars in the visual effect corresponds to the value of the average user-rating. In this example, the visual representation is not trivial, as the stars that are used to visualize the user rating are a novel visual representation that does not exist in the original product webpage. Another example is a visual effect for representing a reduction in the price, a visual effect for representing the degree of infection of a car, and the like. These visual representation enrich the video, and enable displaying information in a non-trivial way that is more suitable for video, usually having a dynamic nature and not just a static one (e.g., not to display text as is, but rather generate a visual effect that depends on its value).

More generally, visual effects and transitions may depend on the product attributes or on the business attributes. For example. use small or big fonts for displaying a price based on the value of the price or based on the business attributes such as the product category (fashion, automotive, and the like), or based on the target audience (e.g., youngsters). Moreover, the existence of some visual elements may directly depend on the meta-data, for example—adding an animation that corresponds to a “summer sale” whenever the existence of the notion “summer sale” (either as exact phrase, or based on text analysis algorithms) is automatically detected from the web-pages.

### Creating a Video for Visualizing a Product Collection

In accordance with some embodiments of the present invention, the input set of meta-data and product images corresponds to a product collection, being a collection of products that are associated to some mutual asset or event (store, sell event, seller, manufacturer, etc.). In this case, the visualization may use a special story for a collection, optionally mixing information from multiple products. This story may defer from a single-product video in several ways, for example (a) by displaying multiple prices, optionally when each product is attached with the relevant price; and (b) by displaying multiple products at the same time (i.e., a mosaic of products).

In accordance with some embodiments of the present invention, meta-data that is relevant to a specific object (e.g., prices, information about a car, sizes, and the like) may be added in a position that depends on the detected location of the product inside the image, for example near the borders of the detected product.

### Adding Stock Footage

In accordance with some embodiments of the present invention, instead of (or in addition to) footage extracted from the input product webpages using web-scrapping, footage can also be added to the produced video via automatic stock footage selection. This selection can be done automatically based on text analysis, for example, based on analysis of the product description, analysis of the user recommendations, and the like. More generally, the stock footage selection may be based on meta-data extracted from the product webpage. Stock footage selection may also use visual analysis of the footage extracted from the input product webpages, for example, by selecting stock footage that is similar or has some relevancy to the extracted footage.

As an example, consider a product webpage describing a restaurant that offers a special reduction. Possible stock images or videos that can be added may be a photo of a person eating (relevant to the category/field of the business), a photo of happy people (based on emotion or sentiment analysis of the page), a photo that is relevant to the special reduction (e.g., a general animation for illustrating a discount), or photos of the same restaurant that were extracted from external resources based on the analysis of the page (e.g., by extracting key words or key phrases and searching for relevant footage via Google Image Search).

### Post Editing

In accordance with some embodiments of the present invention, after creating a produced video to visualize a product, in a fully automatic way, the user may be able to view and modify the produced video. There are two major ways to enable the user applying modifications to the editing:

(a) Letting the user modify the pieces of information that were extracted in the web-scrapping, for example, change the product name or store name, change other textual elements, change or replace selected footage. The user may also be able to change general editing parameters, such as the editing style or the attached music. In this case, after the modifications, the product visualization can be re-run, creating a new produced video that is based on the modified input.
(b) Alternatively, the fully automatic stage can generate a timeline, or a full “editing project”, which can be directly manipulated by the user. The difference of this option from the previous one is that, in option (a), the user controls mainly the input, while, in option (b), the user also controls the editing itself and can directly manipulate the resulting movie (e.g., crop clips, change the order of selected shots, change the placement of text messages, modify visual elements, and the like).

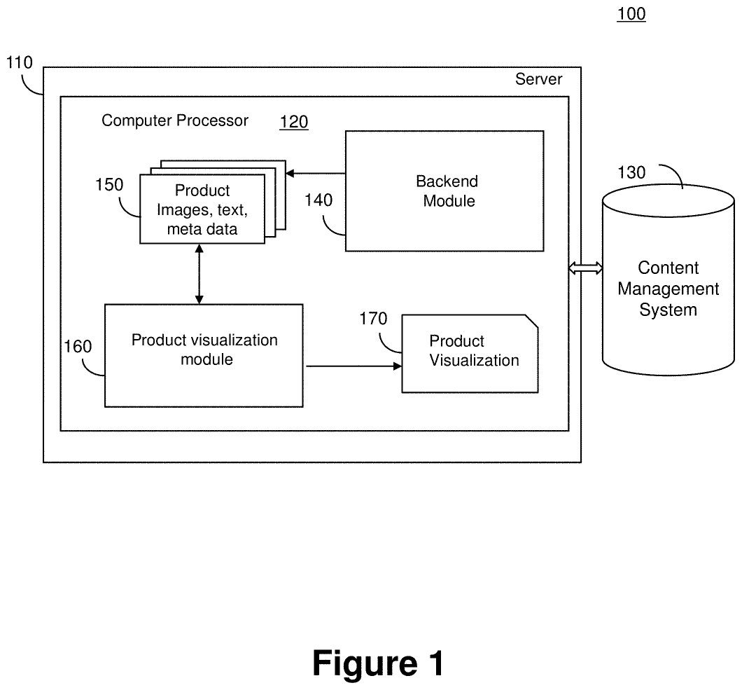

FIG. 1 is a block diagram illustrating a non-limiting exemplary system 100 in accordance with some embodiments of the present invention. Server 110 may be connected possibly over network to a content management system (CMS) 130. CMS 130 may include at least one of: product listing, product catalog, product webpages database and the like.

In accordance with some embodiments of the present invention, server 110 may include a backend module 140 implemented on computer processor 120 and configured to obtain one or more product images and meta-data linked to a specific product 150 from CMS 130. Alternatively, backend module may be configured to obtain product images and meta-data linked to a specific product via web scrapping.

Server 110 may include a product visualization 160 implemented on computer processor 120 and may be configured to: select a product visualization instruction set from a plurality of product visualization instruction sets; modify the product visualization instruction set based on at least one of: content of the product images, and content of the meta-data linked to the product, by adjusting one or more instructions in the instruction set to yield a modified product visualization instruction set; and apply the modified product visualization instruction set to the product images and the meta-data linked to the product, to generate a visualization of the product 170.

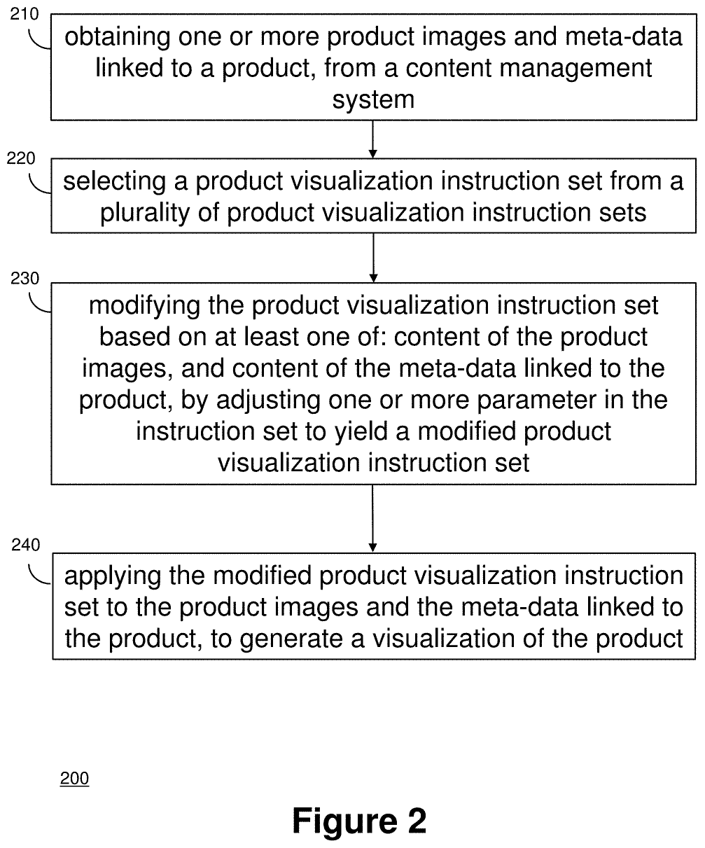

FIG. 2 is a flowchart diagram illustrating a non-limiting exemplary method 200 of automatically generating a product visualization using video, based on meta data obtained from a content management system (CMS), in accordance with some embodiments of the present invention. Method 200 may include the following steps: obtaining one or more product images and meta-data linked to the product from the CMS 210; selecting a product visualization instruction set from a plurality of product visualization instruction sets 220; modifying the product visualization instruction set based on at least one of: content of the product images, and content of the meta-data linked to the product, by adjusting one or more parameter in the instruction set to yield a modified product visualization instruction set 230; and applying the modified product visualization instruction set to the product images and the meta-data linked to the product, to generate a visualization of the product 240.

According to some embodiments of the present invention, the product visualization may include a sequence of frames wherein at least one of the frames exhibits at least part of one or more of the product images together with visual representation of one or more of the meta data.

According to some embodiments of the present invention, method 200 may further include a step of analyzing a content of the product images wherein the modifying is based at least in part, on the analyzed content.

According to some embodiments of the present invention, method 200 may further include the step of rendering the sequence of frames into a video. This rendering may include further adding visual effects and transitions, and usually also include a video encoding process.

According to some embodiments of the present invention, step 210 of obtaining from the CMS is carried out via web scrapping.

According to some embodiments of the present invention, step 210 of obtaining from the CMS is carried out, at least in part, via natural language processing (NLP).

According to some embodiments of the present invention, the instruction set may be configured so that product visualization complies with predefined advertisement format requirements. The advertisement format requirements may include at least one of: aspect ratio (e.g. square format for some social networks), video duration (e.g. having duration limit such as 10 seconds), and branding specification (e.g., starting with the logo of the company owning the product). These requirements may be provided from a third-party source or kept on a library on the server. Thus, the product visualization can be seamlessly integrated in online advertisement campaigns.

According to some embodiments of the present invention, the modifying step 230 may include changing of a position within the frame of at least one element of the product visualization.

According to some embodiments of the present invention, the modifying step 230 may include changing an order or timing of the frames within the product visualization.

According to some embodiments of the present invention, the modifying step 230 may include changing a design of at least one visual element within the product visualization.

According to some embodiments of the present invention, the modifying step 230 may include changing a selection of portions from product images. Additionally, changing the selection of the portions from product images may include cropping at least one product image, based on content of the product image and/or geometry thereof. The cropping may be based, for example, on detection of the visualized product within of the image, such as in the case of an image of a man with a product, which is a common case especially in the fashion industry.

According to some embodiments of the present invention, method 200 may further include the step of analyzing a content of the product images and modifying the product visualization instruction set based at least in part, on the analyzed content.

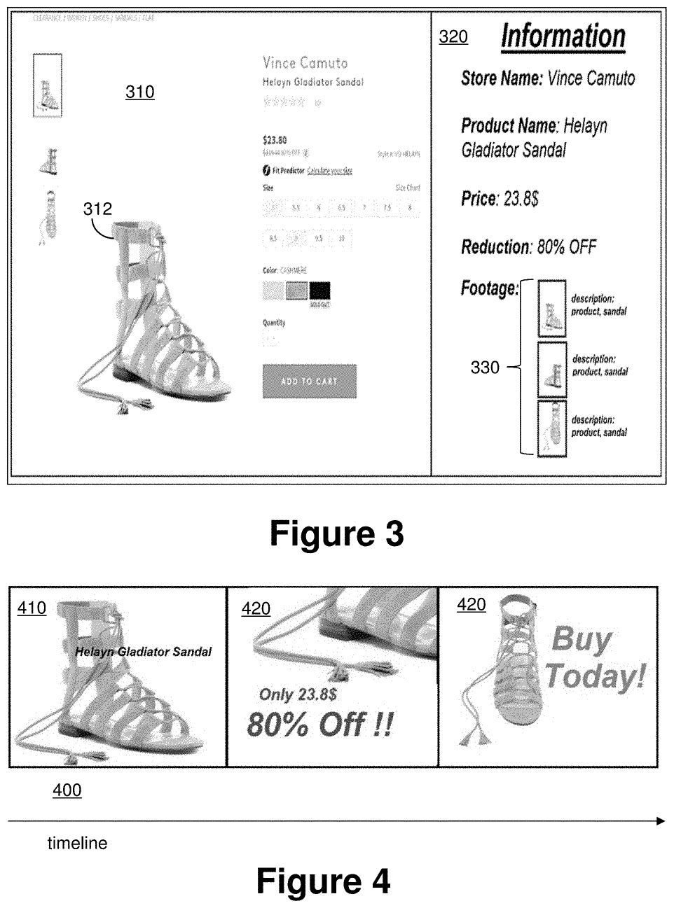

FIG. 3 is a diagram illustrating an exemplary web page extraction in accordance with some embodiments of the present invention. Product webpage 310 may present a product 312 and various meta data linked to the product. The product meta data may include at least one of: product price, product price reduction, product availability, store name, and product user-rating, similar accessories, and the like. All these details are gathered in a structured manner on product extract 320 showing all meta data and a plurality of product images 330 ready for use by the product visualization module.

FIG. 4 is a timeline diagram illustrating a non-limiting exemplary product visualization in accordance with some embodiments of the present invention. In this schematic example, a timeline of a produced video is shown. Product visualization 400 is effectively a video production that has been automatically generated from the webpage 310 (and the extracted information 320. It should be noted that the way to represent different information pieces can vary, and it depends both on the editing style and on the information itself. In this example, the information shown in video 400 includes two photos, product name, price and reduction information, and a call to action (which is generated in this example but can depend on the extracted information).

It should further be noted also that the story telling as demonstrated in product visualization 400 displays only a portion of the first photo in the second shot, meaning the back part and the laces of the sandal. Partial framing can be used to enrich the video when there is a limited footage and to enable the user to focus of parts of the product. These considerations may include which portions of the product to display and when may be decided by a story-telling optimization as part of the product visualization.

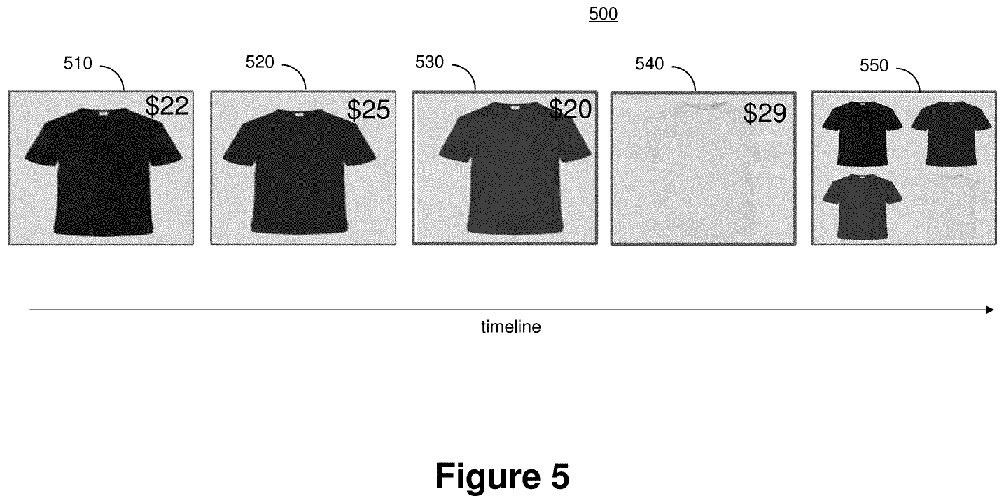

FIG. 5 is a timeline diagram illustrating a non-limiting exemplary product visualization 500 of a product collection (here, of shirts) in accordance with some embodiments of the present invention. According to some embodiments of the present invention, the product may be in the form of a product collection comprising a plurality of products having a common association. The common association may include at least one of: store, manufacturer, brand, event, seller, supplier, and product attribute.

According to some embodiments of the present invention, the product visualization exhibits for each product in the product collection, at least one frame that includes an image and a visualized meta data of the product. In the example shown in product collection visualization 500 each one of shots 510-540 shows a different member of the product collection and an associated price and the final shot 550 shows all of the products in the product collection (without the prices).

According to some embodiments of the present invention, the product collection visualization 500 may include at least one frame that includes two or more product images from the product collection.

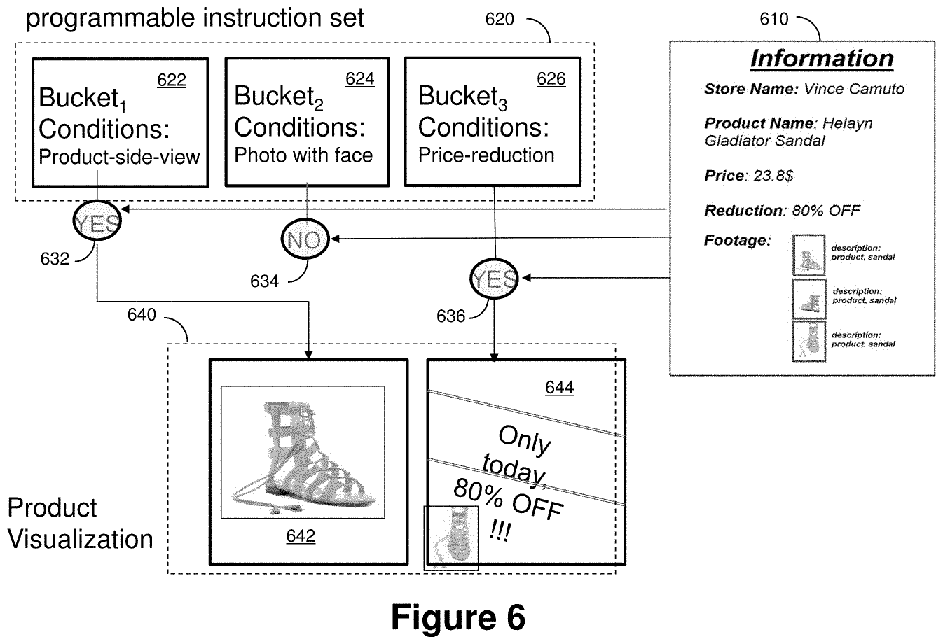

FIG. 6 is a block diagram illustrating a non-limiting exemplary implementation for the product visualization generation process in accordance with some embodiments of the present invention. Product extract 610 maintains all product images and associated metadata. According to some embodiments of the present invention, the instruction set 620 may include at least two buckets (622, 624, and 626), wherein each frame or shot 642, 644 of the product visualization 640 is linked to at least one of the buckets (622 and 626 in this example) and wherein at least one of the buckets comprises at least one of: a condition for including the bucket within the modified product visualization instruction set, and a criterion for selection of a product image to be used in the bucket that affects a decision (e.g., 632, 634, and 636) of whether and which product image and visualized meta data to include in product visualization 640. In some embodiments of the invention, some buckets may include visual placement instructions which may be modified according to the product meta-data or the content of the product images. For example, instruction of placing the price in a relatively free space in the image (e.g., that doesn't occlude an important content in the image). According to some embodiments of the invention, some buckets may include design instructions that will be modified based on the product meta-data or the content of the product images, for example, the color of the text may be modified according to the background portion of the image, as extracted using visual analysis of the corresponding product image.

According to some embodiments of the present invention, the criterion and the condition are based, at least in part, on whether a product image is a canonical product image or a non-canonical product image. A canonical representation of a product is usually the product on its own, meaning no meaningful background or association to another object are presented and usually the product is occupying a large portion of the image. In many cases, a canonical view of the product will be shown on top of a white or transparent background.

According to some embodiments of the present invention, the instruction set may include at least one instruction to include at least one item from a stock library in the product visualization, and wherein the item is selected based on content of the product meta data.

In order to implement the method according to some embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which may include one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures and examples. It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional elements.

It is to be understood that where the claims or specification refer to “a” or “an” element, such reference is not be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of automatically generating a product visualization using video based on meta data obtained from a content management system (CMS), the method comprising:
obtaining one or more product images and meta-data linked to said product from said CMS;
selecting a product visualization instruction set from a plurality of product visualization instruction sets;
modifying the product visualization instruction set based on at least one of: content of the product images, and content of the meta-data linked to said product, by adjusting one or more instructions in the instruction set to yield a modified product visualization instruction set; and
applying said modified product visualization instruction set to the product images and the meta-data linked to said product, to generate a visualization of said product,
wherein said product visualization comprises a sequence of frames, wherein at least one of the frames includes one or more of the product images together with a visual representation of one or more of the meta data.

2. The method according to claim 1, further comprising analyzing a content of said product images, and wherein the modifying is based at least in part on said content.

3. The method according to claim 1, further comprising rendering said sequence of frames into a video.

4. The method according to claim 1, wherein the instruction set is configured to generate a product visualization that complies with predefined advertisement format requirements.

5. The method according to claim 4, wherein the advertisement format requirements include at least one of: aspect ratio, video duration, and branding specification.

6. The method according to claim 1, wherein said product comprises a product collection, being a plurality of products having a common association.

7. The method according to claim 6, wherein the common association comprises at least one of: store, manufacturer, brand, event, seller, supplier, and product attribute.

8. The method according to claim 6, wherein the product visualization exhibits for each product in the product collection, at least one frame that includes an image and a visualized meta data of said product.

9. The method according to claim 6, wherein the product visualization comprises at least one frame that includes two or more product images from the product collection

10. The method according to claim 1, wherein said modifying comprises changing of a position within the frame of at least one element of the product visualization.

11. The method according to claim 1, wherein said modifying comprises changing an order or timing of the frames within the product visualization.

12. The method according to claim 1, wherein said modifying comprises changing a design of at least one visual element within the product visualization.

13. The method according to claim 1, wherein said modifying comprises changing a selection of portions from said one or more product images.

14. The method according to claim 13, wherein said changing a selection of portions from said one or more product images comprises cropping at least one product image, based on content of the product image and/or geometry thereof.

15. The method according to claim 1, wherein said CMS comprises at least one of: product listing, product catalog, product webpages database.

16. The method according to claim 1, wherein said instruction set comprises at least two buckets, wherein each frame is linked to at least one of the buckets and wherein at least one of the buckets comprises at least one of:
a condition for including the bucket within the modified product visualization instruction set, and
a criterion for a selection of a product image to be used in the bucket.

17. The method according to claim 16, wherein said criterion and said condition are based, at least in part, on whether a product image is a canonical product image or a non-canonical product image.

18. The method according to claim 1, wherein the instruction set comprises at least one instruction to include at least one item from a stock library in the product visualization, and wherein said item is selected based on content of the product meta data.

19. The method according to claim 1, wherein the product meta data comprises at least one of: product price, product price reduction, product availability, store name, and product user-rating.

20. The method according to claim 1, wherein the obtaining from the CMS is carried out via web scrapping.

21. The method according to claim 1, wherein the obtaining from the CMS is carried out, at least in part, via natural language processing (NLP).

22. A non-transitory computer readable medium for automatically generating a product visualization using video based on meta data obtained from a content management system (CMS), comprising a set of instructions that, when executed, cause at least one computer processor to:
obtain one or more product images and meta-data linked to said product from said CMS;
selecting a product visualization instruction set from a plurality of product visualization instruction sets;
modify the product visualization instruction set based on at least one of: content of the product images, and content of the meta-data linked to said product, by adjusting one or more instructions in the instruction set to yield a modified product visualization instruction set; and
apply said modified product visualization instruction set to the product images and the meta-data linked to said product, to generate a visualization of said product,
wherein said product visualization comprises a sequence of frames, wherein at least one of the frames includes one or more of the product images together with a visual representation of one or more of the meta data.
